(19) United States
(12) Patent Application Publication
(10) Pub. No.: US 2021/0133867 A1
(43) Pub. Date: May 6, 2021

(54) INTEGRATED LOAN ORIGINATION AND CUSTOMER RELATIONSHIP MANAGEMENT SYSTEM

(71) Applicant: Patch of Land, Inc, Sherman Oaks, CA (US)

(72) Inventors: Robert Greenberg, Dallas, TX (US); Sanjay Prajapati, Santa Clarita, CA (US); Chelsea Strong, Encino, CA (US)

(73) Assignee: Patch of Land, Inc, Sherman Oaks, CA (US)

(21) Appl. No.: 16/671,110

(22) Filed: Oct. 31, 2019

(51) Int. Cl. G06Q 40/02; G06Q 30/00; G06Q 10/10

(52) U.S. Cl. CPC G06Q 40/025; G06Q 10/10; G06Q 30/01

(57) ABSTRACT

An integrated loan origination system and customer relationship management computer-implement platform has a memory device that stores an integrated loan origination system and customer relationship management data structure. Further, a receiver receives, from a lender computer-implemented platform, a lead for loan origination. Additionally, a processor invokes, without an application programming interface, a customer relationship management engine and a loan origination engine. The customer relationship management engine determines that generating a new lead object for the lead would impose a redundancy, merges the lead data into an existing lead object in the integrated loan origination system and customer relationship management data structure without generating a new lead object, and generates an alert based on the redundancy.

### BACKGROUND

### 1. Field

This disclosure generally relates to computing systems. More particularly, the disclosure relates to the field of financial computing systems.

### 2. General Background

In order to process a loan, such as a mortgage, many lenders have a detailed process called loan origination, which outlines how the loan is to be handled from the start of the loan application process all the way to the funding of the loan at closing. Typically, the loan origination process has involved a significant number of individuals (e.g., loan officer, processor, underwriter, closing department, etc.) that participate throughout the different stages of the loan origination process. Although advances in technology have helped spur automation in many industries, the lending industry has not kept up with the pace of such industries. Many tasks continue to be performed manually by humans employed by a lender.

Where technological infrastructure has been put into place, it is often fraught with computing inefficiencies and errors resulting from different computing systems attempting to indirectly communicate with one another. For example, if a computing system relies on some of its core functionality to be performed by another computing system, a working function call to the Application Programming Interface (“API”) of the other computing system becomes paramount. Yet, such reliance often leads to system bottlenecks because updates/modifications to the API may lead to errors that may take a significant amount of time to fix. In an industry that typically has some hesitation toward technological advances, such errors often lead to further lack of interest in technological advancement.

Accordingly, many current technological configurations for loan origination necessitate significant amounts of time and resources to conduct loan originations, while still dealing with the specter of frequently having to rely on third-party technological solutions for core functionality.

### SUMMARY

An integrated loan origination system (“LOS”) and customer relationship management (“CRM”) computer-implement platform has a memory device that stores an integrated LOS and CRM data structure. Further, a receiver receives, from a lender computer-implemented platform, a lead for loan origination. Additionally, a processor invokes, without an API, a CRM engine and an LOS engine. The CRM engine determines that generating a new lead object for the lead would impose a redundancy, merges the lead data into an existing lead object in the integrated LOS and CRM data structure without generating a new lead object, and generates an alert based on the redundancy. Moreover, the integrated LOS and CRM computer-implement platform has a transmitter that routes the alert and a service level agreement (“SLA”), from the CRM engine to a computing device corresponding to an assigned user of the lender computer-implemented platform that was previously assigned to the lead object. The SLA imposes a timeline for a task associated with the lead object.

As an alternative, a computer program may have a computer readable storage device with a computer readable program stored thereon that implements the functionality of the aforementioned integrated LOS and CRM system. As yet another alternative, a process that utilizes a processor may implement the functionality of the aforementioned integrated LOS and CRM system.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a LOS/CRM system that implements an integrated LOS/CRM platform for communication with various other computer-implemented platforms.

FIG. 2 illustrates a system configuration for the integrated LOS/CRM platform illustrated in FIG. 1.

FIG. 3 illustrates the interaction between various components of the CRM engine and the LOS engine.

FIG. 4 illustrates an alert configuration that may be implemented by the alert engine illustrated in FIG. 1.

FIG. 5 illustrates a process that may be utilized by the integrated LOS/CRM platform to perform both customer relationship management and loan origination.

### DETAILED DESCRIPTION

An integrated LOS/CRM system is provided to seamlessly interweave customer relationship data with loan origination data. By providing direct access, without use of an API, to both LOS data and CRM data on a single computer-implemented platform, the integrated LOS/CRM system reduces unnecessary utilization of computing resources and improves operational efficiencies. For example, the integrated LOS/CRM system may utilize one or more SLAs to provide one or more automatic alerts to computing devices (e.g., personal computer (“PC”), laptop computer, smartphone, tablet device, smartwatch, smart wearable, etc.) associated with human participants in the loan origination process. Given that the loan origination process often involves significant time delays in the human pipeline (e.g., a paper document is lost amongst the humans responsible for its possession), the integrated LOS/CRM system may automatically track documents and impose timelines sent via the alerts to responsible parties to perform assigned tasks. As an example, the integrated LOS/CRM system may be utilized in private lending money configurations. (Alternatively, the integrated LOS/CRM system may be utilized in other configurations.)

By integrating CRM data (e.g., lead generation to conversion data) into loan origination data, the integrated LOS/CRM system may enhance not only the processing of a current loan, but also that of future loans. For example, the LOS/CRM system may also have, or be in operable communication with, an artificial intelligence (“AI—”) system that generates predictive analytics. Based on previous interactions with a particular loan applicant, or a similarly situated loan applicant, the LOS/CRM system 100 may generate a probability assessment as to whether or not the loan origination process will conclude in a closing.

Furthermore, the LOS/CRM system may utilize an LOS/CRM data structure that ties together the loan origination data with the customer relationship data. As opposed to having to rely on manual reentry of data for recurring applicants and/or properties for each new loan application, the LOS/CRM system may access such data via the LOS/CRM data structure. Ultimately, the LOS/CRM system maintains up-to-date data regarding borrowers across a plurality of interfaces and multiple stages of loan origination, which are essentially tied together via the LOS/CRM data structure. In contrast with the cumbersome and incomplete communication pathways of previous configurations, the LOS/CRM system 100 provides direct access to data, without bottlenecks to core functionality. For example, the LOS/CRM data structure may maintain a document holding list that flows throughout the loan origination pipeline, thereby allowing various users in the pipeline to view the locations of the current documents in the loan origination process. The LOS/CRM system may also generate alerts to all necessary participants within a group corresponding to a particular stage of the origination process regarding any loan origination updates and remaining items on a “needs list” required to close the loan. In particular, the type of property and the type of loan may dictate what documents are necessary for the needs list.

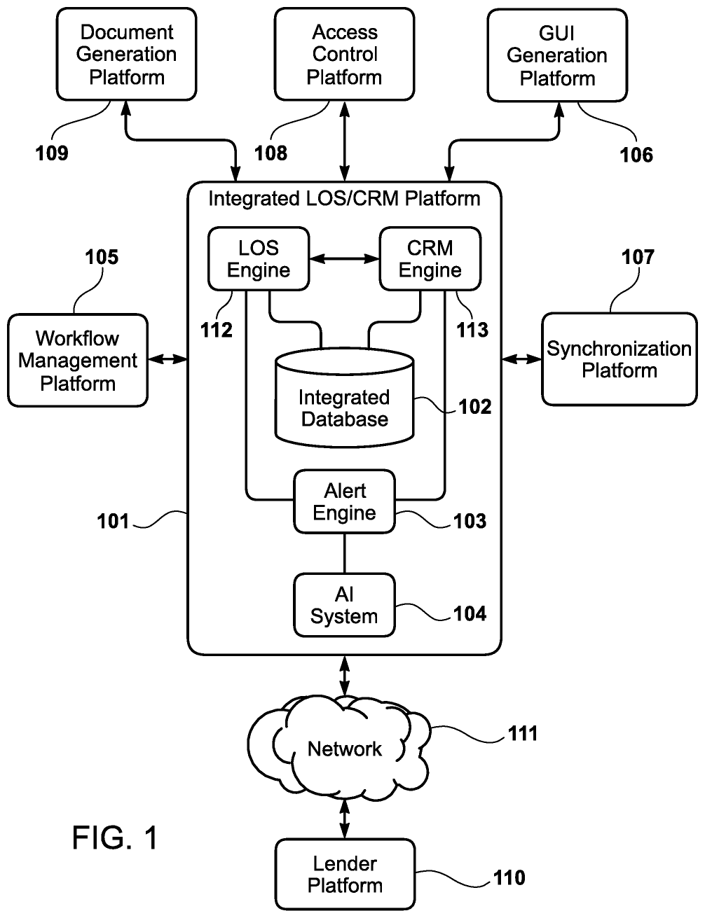

FIG. 1 illustrates a LOS/CRM system 100 that implements an integrated LOS/CRM platform 101 for communication with various other computer-implemented platforms. In particular, the integrated LOS/CRM platform 101 may have an integrated database 102, which ties together customer relationship data, from a CRM engine 113, and loan origination data, from an LOS engine 112, into a single data structure for direct, improved data access without an API, thereby reducing the amount of computing resources that would have been utilized to access such data via a network. Furthermore, the integrated LOS/CRM platform 101 has an alert engine 103 that generate alerts (e.g., via one or more SLAs) to be sent to various computing devices operated by various human operators throughout the loan origination process. Optionally, the integrated LOS/CRM platform 101 may also have an AI system 104 that automatically generates recommendations, which may be tied to the alert engine 103. In other words, the AI system 104 may recommend, or determine, the content of the alerts generated and transmitted by the alert engine 103. Alternatively, or additionally, the AI system 104 may generate recommendations and/or commands that are utilized by the integrated LOS/CRM platform 101 for purposes other than alerts. For example, the AI system 104 may be utilized to compose the integrated LOS/CRM data structure stored in the integrated database 102, monitor error detection, manage computing resources internal, and external, to the integrated LOS/CRM 101, and generate probability assessments for closing a loan for a particular lead.

Although the integrated LOS/CRM platform 101 removes the necessity for use of an API to access either, or both, of the loan origination and customer relationship management data, the integrated LOS/CRM platform 101 provides access, locally (through a local network) or externally (through a remote network), to a variety of platforms that may further streamline the loan origination and customer relationship management processes. In essence, the LOS/CRM platform 101 may act as a middleware platform that is directly accessible by a lender computer-implemented platform via a network 111, and which may access external platforms, potentially via APIs, to facilitate the loan origination process.

For instance, the integrated LOS/CRM platform 101 may access, potentially via an API over a network, a synchronization platform 107 to synchronize the loan origination data and the customer relationship management data. The synchronization platform 107 may remove redundancies throughout the integrated LOS/CRM platform 101 by eliminating data duplication of data permeating through the integrated LOS/CRM platform 101 as a result of interactions with multiple computer-implemented platforms. In other words, the LOS/CRM platform 101 may make one or more function calls to the synchronization platform 107 when data is being ingested into the LOS/CRM platform 101 to ensure that data is not being duplicated through the integrated LOS/CRM platform 101; such automatic redundancy minimization/avoidance configuration allows the lender computer-implemented platform 110 to improve the overall processing speed of large multitudes of transactions that need to be processed in real-time (i.e., humanly imperceptible amount of time), or substantial real-time, while also improving the accuracy of data relied upon by the AI system 104 for generating recommendations/commands. The synchronization platform 107 may also be utilized by the lender computer-implemented platform 110 to generate the integrated LOS/CRM data structure according to a plurality of standardized field names. Rather than having to discern between different nomenclatures for the same set of data from different computer-implemented platforms/systems, which can lead to numerous errors and processing delays, the synchronization platform 107 may establish a predefined set of field indicia, and re-categorize data from the different computer-implemented platforms based upon the predefined set of field indicia.

Furthermore, the integrated LOS/CRM platform 101 may access, potentially via an API over a network, an access control platform 108 that provides digital rights management (“DRM”) for data throughout the loan origination pipeline. For instance, the access control platform 108 may automatically enforce DRM on a field-by-field basis of the LOS/CRM data structure to ensure that modifications to the data within the LOS/CRM data structure are restricted to one or more users with associated permissions. Furthermore, the permissions may be adjusted on a time/stage basis within the loan origination process. For example, a user in the closing department of the lender may not have access to a particular field until the loan reaches the closing stage, whereas a user in the underwriting department may have access to that same field before the closing stage to then have that access restricted at the closing stage. In one embodiment, the access control platform 108 allows the integrated LOS/CRM platform 101 to generate an access control list (“ACL”) that lists the various users and corresponding access rights.

Additionally, the integrated LOS/CRM platform 101 may access, potentially via an API over a network, a workflow management platform 105 that automatically assigns tasks to computing resources and/or human operators participating in the loan origination process. For example, the integrated LOS/CRM platform 101 may utilize the alert engine 103 to generate context-specific communications for particular tasks to be performed during the loan origination process. The AI system 104 may automatically generate such alerts by analyzing electronic communications between users with corresponding permissions to perform tasks at a particular stage of the workflow, and then generate tasks via the workflow platform 105 to be performed by users with permissions at the current stage of the loan origination process, as determined via the access control platform 108. In one embodiment, the alert engine 103 may generate a user-specific alert based on one or more tasks generated by the workflow management platform 105. In another embodiment, the alert engine 103 may generate group-based alerts via a messaging computer-implemented platform, which sends a message to each of the users in the group via their corresponding computing devices. The messaging computer-implemented platform may then allow users within a particular group to also communicate with each other regarding the alert received from the alert engine 103. For example, the workflow management platform 105 may indicate that the closing department should process a particular set of closing documents within a particular time period, and the alert engine 103 may utilize the computer-implemented messaging platform to send a one-to-many message to the particular members of the closing department handling a particular loan. Those members of the closing department may then directly communicate with one another regarding the documents that formed the basis for the alert.

Given that the loan origination process is somewhat document-intensive, the integrated LOS/CRM platform 101 may also access, potentially via an API over a network, a document generation platform 109 to dynamically generate documents based on one or more conditional criteria being met. In essence, the document generation platform 109 may dynamically build one or more templates that may be used to generate documents for the workflow. For example, the LOS/CRM platform 101 may dynamically generate the closing documents from one or more templates specific to each state and the purpose of the loans, as well as the property types. As a result, the LOS/CRM platform 101 may dynamically generate loan documents without human review. In essence, the LOS/CRM platform 101 may dynamically retrieve data from fields of the integrated database 102 that meet the requirements of each state.

Finally, the integrated LOS/CRM platform 101 may also access, potentially via an API over a network, a graphical user interface (“GUI”) generation platform 106 that generates a document-centric interface for workflow performed by the workflow management platform 105. For example, the document-centric interface may display error-based indicia on a document-by-document basis, allowing for identification of potential workflow errors. The document-centric interface may be role-specific and/or task specific.

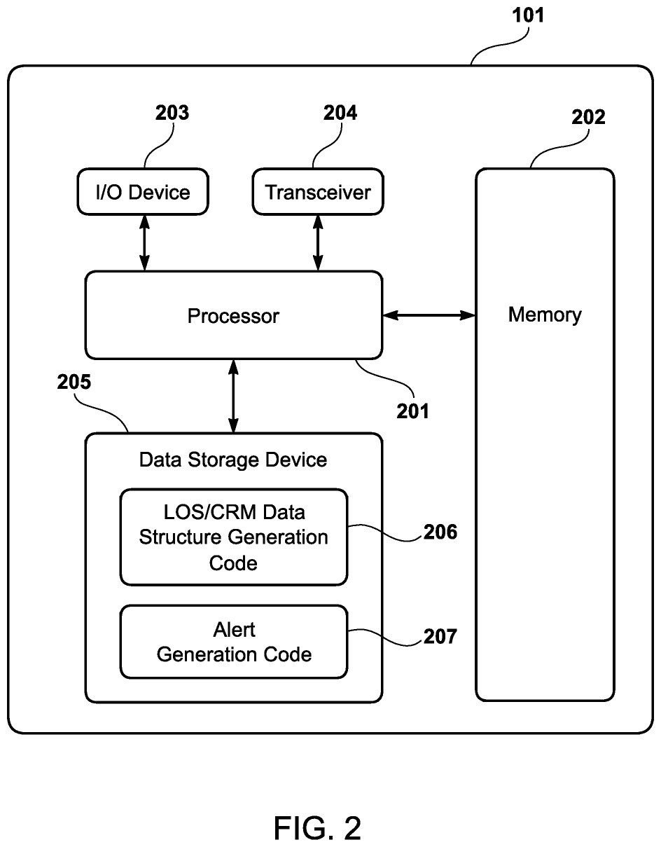

FIG. 2 illustrates a system configuration for the integrated LOS/CRM platform 101 illustrated in FIG. 1. In particular, a processor 201, which may be specialized for generating data structures and/or alerts may be used to perform the operations illustrated in FIG. 1 for LOS/CRM integration. For example, the processor 201 may be capable of generating an LOS/CRM data structure. Furthermore, a memory device 202 may store the LOS/CRM data structure, or portions thereof, for processing by the processor 201 prior to storage in the integrated database 102, illustrated in FIG. 1. In essence, the LOS/CRM data structure allows the processor 201 to process data faster than configurations that rely on separate LOS and CRM systems, which necessitate additional network resources and bandwidth for communication. The memory device 202 may also store computer readable instructions performed by the processor 201. As an example of such computer readable instructions, a data storage device 205 within the system configuration may store LOS/CRM data structure generation code 206 and alert generation code 207. The memory device 202 may also store computer readable instructions performed by the processor 201. As an example of such computer readable instructions, a data storage device 205 within the system configuration may store LOS/CRM data structure generation code 206 and alert generation code 207. The processor 201 may execute the LOS/CRM data structure generation code 206 to generate the LOS/CRM data structure. Furthermore, the processor 201 may execute the alert generation code 207 to generate one or more alerts for the alert engine 103 illustrated in FIG. 1.

Moreover, the system configuration may have one or more input/output (“I/O”) devices 203 that may receive inputs and provide outputs. Various devices (e.g., keyboard, microphone, mouse, pointing device, hand controller, etc.) may be used for the I/O devices 203. The system configuration may also have a transceiver 204 to send and receive data. Alternatively, a separate transmitter and receiver may be used instead.

The integrated LOS/CRM platform 101 illustrated in FIGS. 1 and 2 provides a seamless bridge, without the necessity of an API, between a CRM system and an LOS system. Given the reliance on similar data objects, the CRM engine 113 and the LOS engine 112 may access the same LOS/CRM data structure stored within the integrated database 102, which further improves processing time, by the processor 201, for interwoven LOS and CRM data; such integrated data also benefits each of the CRM system and the LOS system because each system is able to benefit from the most current data that may not be ordinarily attainable in isolation. For example, the CRM system may provide statistical data about a particular lead that allows the LOS system to assess the probability of a successful loan origination, thereby determining whether the LOS system should even proceed with attempting to convert the lead to a loan closing.

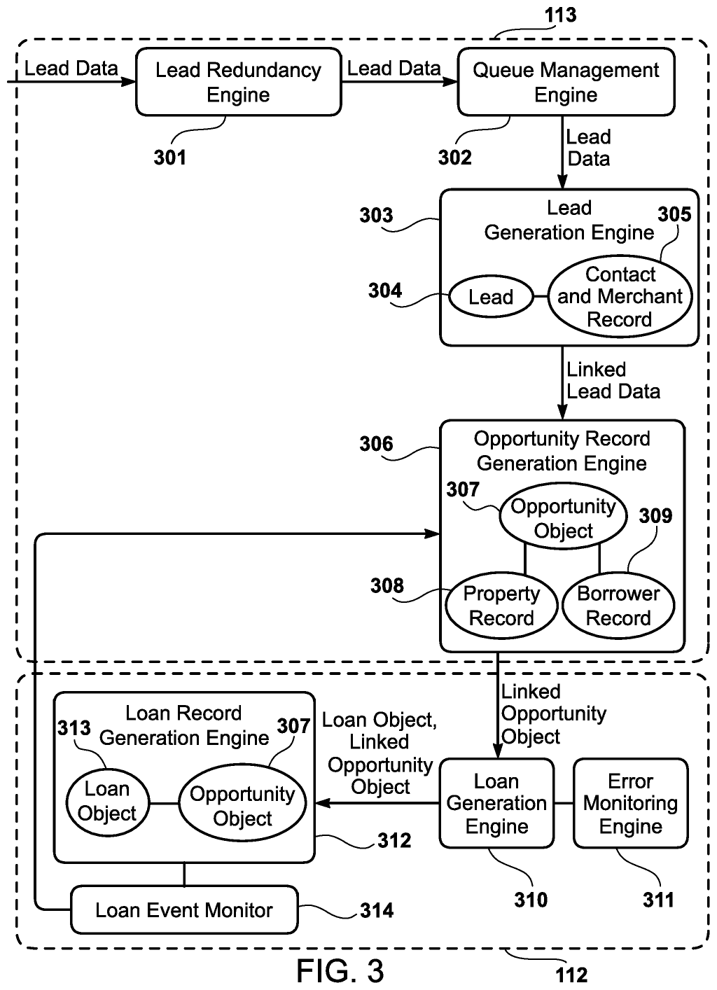

Accordingly, FIG. 3 illustrates the interaction between various components of the CRM engine 113 and the LOS engine 112. In one embodiment, the CRM engine 113 may receive lead data. For example, a potential loan applicant may have expressed interest in possibly applying for a loan via a variety of different ways, such as filling out an online form, placing a telephone call to the lender, etc. In one embodiment, the lead data is received by the lender platform 110, illustrated in FIG. 1, which sends the lead data to the CRM engine 113. In an alternative embodiment, the CRM engine 113 may receive the lead data directly from the potential loan applicant, or indirectly from another system other than the lender platform 110.

At the outset, the CRM engine 113 may have a lead redundancy engine 301, which may be operated by the processor 201 illustrated in FIG. 2, to determine if the incoming lead data is a duplicate or new information. The lead redundancy engine 301 may search the integrated database 102, illustrated in FIG. 1, to fetch any incoming records having the same, or similar, information to that of the lead data (e.g., name, email, phone number, etc.). The lead redundancy engine 301 then compares the incoming lead data to any fetched records. If no fetched records are found, the lead redundancy engine 301 does not perform any redundancy elimination. However, if the lead redundancy engine 301 determines that that one or more fetched records have a similarity to the lead data that exceeds a predetermined confidence threshold, the lead redundancy engine 301 may perform a merge operation to the existing fetched record(s) to include/update the existing fetched record(s) with the new lead data. In other words, the lead redundancy engine 301 prevents, or minimizes the possibility, of having multiple records permeating throughout the integrated LOS/CRM system 100. For example, if redundant records were permitted, such redundancy could lead not only to additional data storage, but also multiple uses of computing resources (e.g., tasks generated by the workflow platform 105) that may assign tasks based on the redundant records. By avoiding, or minimizing such redundancy, the lead redundancy engine 301 improves computing performance of both the CRM engine 113 and the LOS engine 112, which both rely on efficient data access via the LOS/CRM data structure stored in the integrated database 102. In particular, the lead data may be processed by the lead redundancy engine 301 as a lead object having an account record and a contact record. In addition to minimizing the redundancy via the merge operation, the lead redundancy engine 301 may invoke the alert engine 103 to send an alert to a computing device associated with the assigned loan officer about the update/addition. The alert may include an SLA that imposes a timeline for the assigned loan officer to reengage the contact, thereby potentially avoiding expending additional computing resources to route the lead object, as well as potentially other data objects if the loan origination process has already begun, to a different loan officer. As a particular example, the LOS/CRM platform 101 facilitates a second loan to an existing borrower without redundant re-entry of data by the existing borrower.

By way of contrast, if the lead redundancy engine 301 determines that the lead data does not correspond to an existing record, according to the predetermined confidence threshold, the CRM engine 113 sends the lead data to a queue management engine 302. A variety of configurations may be utilized by the queue management engine 302 to assign the lead to an available loan officer. For example, the queue management engine 302 may utilize a round robin configuration that assigns the last-in-queue loan officer from the record pipeline to the loan. (The round robin configuration is just one example; other types of configurations may be used instead to perform queue management.)

Upon selecting a loan officer, via the queue management engine 302, the CRM engine 113 may utilize a lead generation engine 303 to generate a lead object 304, as well as a contact and account record 305. In particular, the lead generation engine 303 may link the lead object 304 to the contact and account record 305. As a result, an update to one object will be automatically permeated through the integrated database 102 to another object. In one embodiment, the LOS/CRM data structure stored in the integrated database 102 may include one or more rules that automatically invoke, via the processor 201, an update to a linked data object when the other object is updated.

Furthermore, the CRM engine 113 may utilize an opportunity record generation engine 306 to generate an opportunity object 307. For example, the opportunity object 307 may describe a property that is the subject of the potential loan. The CRM engine 113 may then generate a property record 308 and a borrower record 309 that are linked to the opportunity object 307. The CRM engine 113 may then send the linked opportunity object 307 to the LOS engine 112. In particular, the LOS engine 112 may have a loan generation engine 310 that generates a loan object based on the linked opportunity object 307. Prior to advancing throughout the loan origination process, the LOS engine 112 may utilize an error monitoring engine 311 to ensure that the generated loan object does not have any errors. Furthermore, the loan generation engine 310 may send the loan object 313 and the linked opportunity object 307 to a loan record generation engine 312, which generates a loan record with all of the sub-objects of the opportunity object 307, specifically the property record 308 and the borrower record 309. Finally, the LOS engine 112 may have a loan event monitor 314 that monitors the sub-objects for any updates/modifications, which should then permeated through to the linked sub-objects via the integrated database 102.

By linking various data objects within the integrated LOS/CRM data structure in the integrated database 102, the LOS/CRM platform 101 maintains the integrity of both CRM data and LOS data. In one embodiment, not all of the objects and sub-objects of the CRM engine 113 and the LOS engine 112 are linked. The processor 102 may automatically link the objects and sub-objects that affect data integrity throughout the LOS/CRM system 100. Furthermore, in one embodiment, the LOS/CRM platform 101 may invoke one or more alerts via the alert engine 103 upon an update to a linked object or sub-object. For example, an alert may be transmitted so that a computing device corresponding to LOS operations is alerted to an update to a linked data object performed by a computing device corresponding to CRM operations.

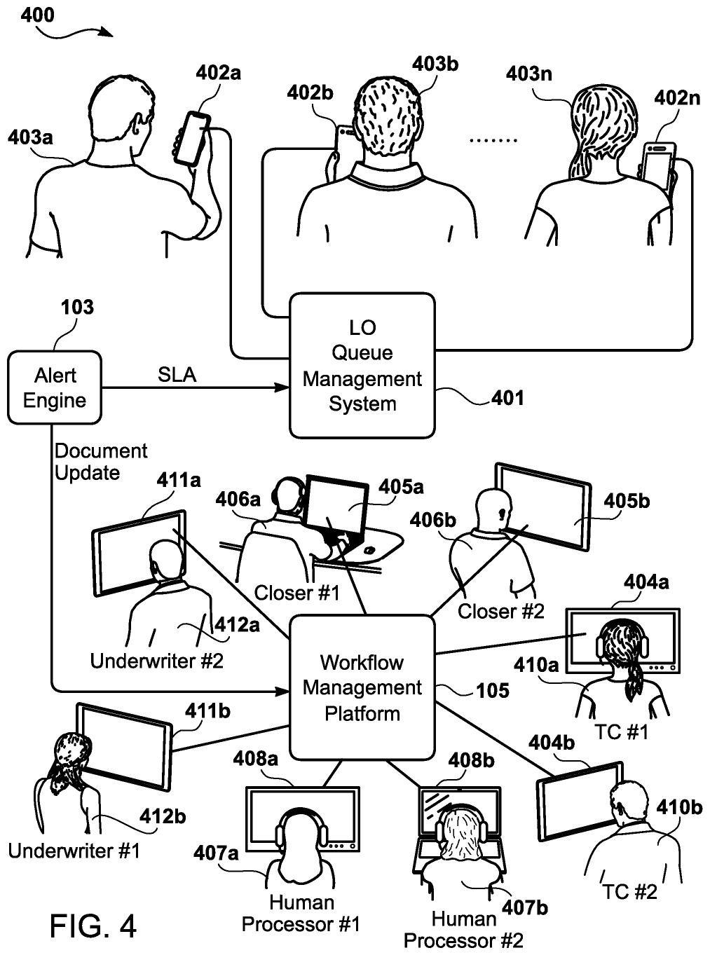

Furthermore, FIG. 4 illustrates an alert configuration 400 that may be implemented by the alert engine 103 illustrated in FIG. 1. The alert engine 103 may send a multitude of various alerts to different components of the LOS/CRM system 100 illustrated in FIG. 1. In particular, the alert engine 103 may send an SLA to an LOS queue management system 401 that manages a queue of a plurality of computing devices 402a-n, each corresponding to one of a plurality of loan officers 403a-n. Additionally, the alert engine 103 may send a document update to the workflow management platform 105 to update a document for each user permitted to view a document according to the access control platform 108, illustrated in FIG. 1. For example, a loan application may be at the closing stage, which may necessitate access by transaction coordinators 410a and 410b situated at computing devices 409a and 409b, human processors 408a and 408b, situated at computing devices 407a and 407b, underwriters 412a and 412b situated at computing devices 411a and 411b, and closers 406a and 406b situated at computing devices 405a and 405b. (Various different roles with permission and quantities of operators and computing devices, other than those illustrated, may receive alerts via the workflow management platform 105 from the alert engine 103.)

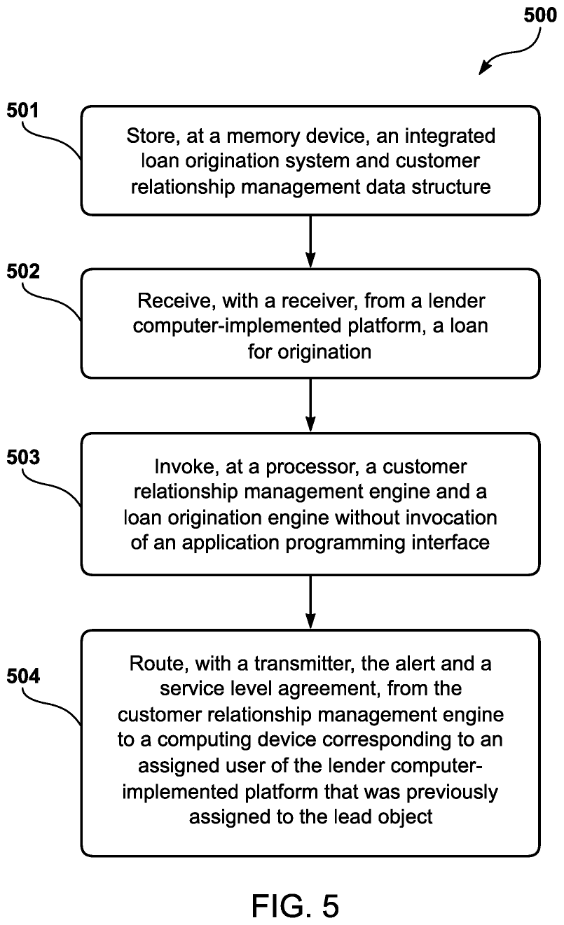

FIG. 5 illustrates a process 500 that may be utilized by the LOS/CRM platform 101 to perform both customer relationship management and loan origination. At a process block 501, the process 500 stores, at the memory device 202 illustrated in FIG. 2, an integrated loan origination system and customer relationship management data structure. Further, at a process block 502, the process 500 receives, with a receiver, from a lender computer-implemented platform 110, a lead for loan origination. Moreover, at a process block 503, the process 500 invoke, at the processor 201, a CRM engine 113 and a loan origination engine 112 without invocation of an API. The CRM engine 113 determines that generating a new lead object for the lead would impose a redundancy, merges the lead data into an existing lead object in the integrated loan origination system and customer relationship management data structure without generating a new lead object, and generates an alert based on the redundancy. Finally, at a process block 504, the process 500 routes, with a transmitter, the alert and an SLA, from the CRM engine 113 to a computing device corresponding to an assigned user of the lender computer-implemented platform 110 that was previously assigned to the lead object. The SLA imposes a timeline for a task associated with the lead object.

Various examples have been provided with respect to the mortgage lending industry. Alternatively, the integrated LOS/CRM platform 101 may be utilized for other types of loans.

A computer is intended herein to include any device that has a specialized processor as described above. For example, a computer may be a personal computer (“PC”), laptop computer, set top box, cell phone, smartphone, tablet device, smart wearable device, portable media player, video player, etc.

It is understood that the apparatuses, systems, computer program products, and processes described herein may also be applied in other types of apparatuses, systems, computer program products, and processes. Those skilled in the art will appreciate that the various adaptations and modifications of the embodiments of the apparatuses described herein may be configured without departing from the scope and spirit of the present apparatuses, systems, computer program products, and processes. Therefore, it is to be understood that, within the scope of the appended claims, the present apparatuses, systems, computer program products, and processes may be practiced other than as specifically described herein.

We claim:

1. An integrated loan origination system and customer relationship management computer-implement platform comprising:
a memory device that stores an integrated loan origination system and customer relationship management data structure;
a receiver that receives, from a lender computer-implemented platform, a lead for loan origination;
a processor that invokes, without an application programming interface, a customer relationship management engine and a loan origination engine, the customer relationship management engine determining that generating a new lead object for the lead would impose a redundancy, merging the lead data into an existing lead object in the integrated loan origination system and customer relationship management data structure without generating a new lead object, and generating an alert based on the redundancy; and
a transmitter that routes the alert and a service level agreement, from the customer relationship management engine to a computing device corresponding to an assigned user of the lender computer-implemented platform that was previously assigned to the lead object, the service level agreement imposing a timeline for a task associated with the lead object.

2. The integrated loan origination system and customer relationship management computer-implement platform of claim 1, wherein the receiver receives, from the lender computer-implemented platform, an additional lead for loan origination.

3. The integrated loan origination system and customer relationship management computer-implement platform of claim 2, wherein the processor invokes the customer relationship management engine and the loan origination engine without invocation of the application programming interface, the customer relationship management engine determining that a new additional lead object would be generated without imposing an additional redundancy.

4. The integrated loan origination system and customer relationship management computer-implement platform of claim 3, wherein the processor invokes the customer relationship management engine to route, via a queue management engine, the additional lead to a lead generation engine that generates a lead object, the lead generation engine linking the lead object to a contact and account record.

5. The integrated loan origination system and customer relationship management computer-implement platform of claim 4, wherein the processor invokes the customer relationship management engine to route, via an opportunity record generation engine, the opportunity record generation engine generating an opportunity object, the opportunity record generation engine generating a linked opportunity object by linking the opportunity object to a first sub-object and a second sub-object, the first sub-object being a property record, the second sub-object being a borrower record, the opportunity object being stored in an integrated database that is accessible by the customer relationship management engine and the loan origination engine without invocation of an additional application programming interface.

6. The integrated loan origination system and customer relationship management computer-implement platform of claim 5, wherein the transmitter sends the linked opportunity object from customer relationship management engine to a loan generation engine that generates a loan object and links the loan object to the opportunity object, the processor storing an automatic update rule in the integrated database based on the an update to one of the loan object and the opportunity object.

7. The integrated loan origination system and customer relationship management computer-implement platform of claim 6, wherein the processor invokes a loan event monitor that monitors the update to the loan object, the processor automatically updating the opportunity object based on the update to the loan object.

8. The integrated loan origination system and customer relationship management computer-implement platform of claim 6, wherein the computer is further caused to invoke, at the processor, a loan event monitor that monitors the update to the opportunity object, the processor automatically updating the loan object based on the update to the opportunity object.

9. A computer program product comprising a non-transitory computer readable medium having a computer readable program stored thereon, wherein the computer readable program when executed on a computer causes the computer to:
store, at a memory device, an integrated loan origination system and customer relationship management data structure;
receive, with a receiver, from a lender computer-implemented platform, a lead for loan origination;
invoke, at a processor, a customer relationship management engine and a loan origination engine without invocation of an application programming interface, the customer relationship management engine determining that generating a new lead object for the lead would impose a redundancy, merging the lead data into an existing lead object in the integrated loan origination system and customer relationship management data structure without generating a new lead object, and generating an alert based on the redundancy; and
route, with a transmitter, the alert and a service level agreement, from the customer relationship management engine to a computing device corresponding to an assigned user of the lender computer-implemented platform that was previously assigned to the lead object, the service level agreement imposing a timeline for a task associated with the lead object.

10. The computer program product of claim 9, wherein the computer is further caused to receive, with the receiver, from the lender computer-implemented platform, an additional lead for loan origination.

11. The computer program product of claim 10, wherein the computer is further caused to invoke, at the processor, the customer relationship management engine and the loan origination engine without invocation of the application programming interface, the customer relationship management engine determining that a new additional lead object would be generated without imposing an additional redundancy.

12. The computer program product of claim 11, wherein the computer is further caused to invoke, at the processor, the customer relationship management engine to route, via a queue management engine, the additional lead to a lead generation engine 303 that generates a lead object, the lead generation engine linking the lead object to a contact and account record.

13. The computer program product of claim 12, wherein the computer is further caused to invoke, at the processor, the customer relationship management engine to route, via an opportunity record generation engine, the opportunity record generation engine generating an opportunity object, the opportunity record generation engine generating a linked opportunity object by linking the opportunity object to a first sub-object and a second sub-object, the first sub-object being a property record, the second sub-object being a borrower record, the opportunity object being stored in an integrated database that is accessible by the customer relationship management engine and the loan origination engine without invocation of an additional application programming interface.

14. The computer program product of claim 13, wherein the computer is further caused to send the linked opportunity object from customer relationship management engine to a loan generation engine that generates a loan object and links the loan object to the opportunity object, the processor storing an automatic update rule in the integrated database based on the an update to one of the loan object and the opportunity object.

15. The computer program product of claim 14, wherein the computer is further caused to invoke, at the processor, a loan event monitor that monitors the update to the loan object, the processor automatically updating the opportunity object based on the update to the loan object.

16. The computer program product of claim 15, wherein the computer is further caused to invoke, at the processor, a loan event monitor that monitors the update to the opportunity object, the processor automatically updating the loan object based on the update to the opportunity object.

17. A process comprising:
storing, at a memory device, an integrated loan origination system and customer relationship management data structure;
receiving, with a receiver, from a lender computer-implemented platform, a lead for loan origination;
invoking, at a processor, a customer relationship management engine and a loan origination engine without invocation of an application programming interface, the customer relationship management engine determining that generating a new lead object for the lead would impose a redundancy, merging the lead data into an existing lead object in the integrated loan origination system and customer relationship management data structure without generating a new lead object, and generating an alert based on the redundancy; and
routing, with a transmitter, the alert and a service level agreement, from the customer relationship management engine to a computing device corresponding to an assigned user of the lender computer-implemented platform that was previously assigned to the lead object, the service level agreement imposing a timeline for a task associated with the lead object.

18. The process of claim 17, further comprising receiving, with the receiver, from the lender computer-implemented platform, an additional lead for loan origination.

19. The process of claim 18, further comprising invoking, at the processor, the customer relationship management engine and the loan origination engine without invocation of the application programming interface, the customer relationship management engine determining that a new additional lead object would be generated without imposing an additional redundancy.

20. The process of claim 19, further comprising invoking, at the processor, the customer relationship management engine to route, via a queue management engine, the additional lead to a lead generation engine 303 that generates a lead object, the lead generation engine linking the lead object to a contact and account record.
